(19) United States
(12) Patent Application Publication
(10) Pub. No.: US 2007/0218886 A1
(43) Pub. Date: Sep. 20, 2007

(54) Radio communication apparatus capable of vibration control

(75) Inventors: Yuji Fujimoto, Tokyo (JP); Sachio Fukunaga, Tokyo (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: KABUSHIKI KAISHA TOSHIBA, Tokyo (JP)

(21) Appl. No.: 11/492,567

(22) Filed: Jul. 25, 2006

(30) Foreign Application Priority Data
Mar. 15, 2006 (JP) 2006-071570

(51) Int. Cl. H04M 3/00

(52) U.S. Cl. 455/418

(57) ABSTRACT

A radio communication apparatus capable of vibration control is provided. The apparatus has an input device, a storage device, a vibrating device and a controller. The storage device includes a storage elememt, and is configured to operate accompanying a mechanical move of the storage elememt. The controller is configured to prevent the storage device from operating upon a determined operation input entered from the input device while the storage device is operating. The controller is configured to make the vibrating device vibrate according to the determined operation input. The controller is configured to make the storage device resume operating after the vibrating device vibrates. The controller is configured to prevent the vibrating device from vibrating for a determined period of time after the storage device resumes operating.

### CROSS REFERENCE TO RELATED APPLICATIONS

This application is based upon and claims the benefit of priority from the prior Japanese Patent Application No. 2006-071570 filed on Mar. 15, 2006; the entire contents of which are incorporated herein by reference.

### FIELD OF THE INVENTION

The present invention relates to a radio communication apparatus including a vibrating device and capable of vibration control, in particular to an apparatus including another device that should remain vibration-free.

### DESCRIPTION OF THE BACKGROUND

A radio communication apparatus is known which has a vibrator that vibrates upon a call arrival and so on. The radio communication apparatus may have a hard disk and is capable of playing a piece of music stored on the hard disk.

The hard disk mentioned above includes a head and a plurality of flat round plates to each of which a quantity of magnetic material is applied by, e.g. a vacuum deposition method. Each of the above plates, called a platter, serves as a storage elememt. The platter rotates and the head moves so that data may be written on the platter and may be read out from the platter.

The vibrator may prevent the head from moving properly by vibrating while the hard disk is being accessed for data writing and reading. In such a case, some of the data may be written on and read out from the hard disk in a wrong way. Further, the head and the platter may possibly come into contact with each other to be damaged, and may make the hard disk unable to operate thereafter.

A method is disclosed in Japanese Patent Publication (Kokai), No. 2003-179671, of preventing a vibrator and a hard disk from vibrating or operating simultaneously even in a case where the vibrator is ready to vibrate while the hard disk is being accessed. According to the above method, the vibrator stops vibrating while the hard disk is operating, and vice versa.

The above method, however, has a problem that it may not be clearly determined whether the hard disk should stop operating or whether the vibrator should stop vibrating. The above method has another problem that a hard disk repeating start-and-stops frequently may dissipate more power or deteriorate more quickly than a hard disk other than the above.

### SUMMARY OF THE INVENTION

Accordingly, an advantage of the present invention is that a radio communication apparatus may control vibration of a vibrating device thereof so as to prevent the device from adversely affecting another device thereof that should remain vibration-free.

To achieve the above advantage, one aspect of the present invention is to provide a radio communication apparatus having an input device, a storage device, a vibrating device and a controller. The storage device includes a storage elememt, and is configured to operate accompanying a mechanical move of the storage elememt. The controller is configured to prevent the storage device from operating upon a determined operation input entered from the input device while the storage device is operating. The controller is configured to make the vibrating device vibrate according to the determined operation input. The controller is configured to make the storage device resume operating after the vibrating device vibrates. The controller is configured to prevent the vibrating device from vibrating for a determined period of time after the storage device resumes operating.

### BRIEF DESCRIPTION OF THE DRAWINGS

FIG. 1 shows an external view of a radio communication apparatus of the embodiment of the present invention.

FIG. 2 is a block diagram of the radio communication apparatus of the embodiment.

FIG. 3 shows entries of a conflict avoidance (C/A) flag set used in the radio communication apparatus of the embodiment.

FIG. 4 is a flow chart of operation of the embodiment in a case where presence of unchecked-unanswered call, etc., is announced by vibration.

FIG. 5 shows a late stage of the flow chart shown in FIG. 4.

FIG. 6 shows a modified late stage of the flow chart shown in FIG. 4.

FIG. 7 is another flow chart of operation of the embodiment in a case where presence of unchecked-unanswered call, etc., is announced by vibration.

FIG. 8 shows a late stage of the flow chart shown in FIG. 7.

FIG. 9 shows a modified late stage of the flow chart shown in FIG. 7.

FIG. 10 is an example of a displayed menu of vibration patterns of the embodiment.

FIG. 11 is a flow chart of operation of the embodiment for preselecting one of the vibration patterns.

FIG. 12 shows a late stage of the flow chart shown in FIG. 11.

FIG. 13 is another flow chart of operation of the embodiment for preselecting one of the vibration patterns.

FIG. 14 shows a late stage of the flow chart shown in FIG. 13.

### DETAILED DESCRIPTION OF THE INVENTION

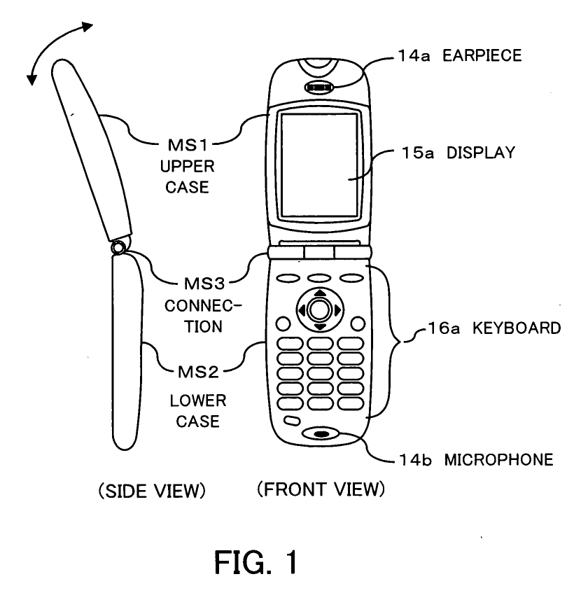

An embodiment of the present invention will be described with reference to FIGS. 1 to 14.

1. Configuration of an Apparatus of the Embodiment

FIG. 1 shows an external view of a radio communication apparatus of the embodiment of the present invention. The radio communication apparatus is capable of playing music. The external view includes a side view on a left side of FIG. 1 and a front view on a right side of FIG. 1. The radio communication apparatus has an upper case MS1 and a lower case MS2 movably connected to each other by a connection MS3. The upper case MS1 may be open or closed to the lower case MS2 by rotating against the lower case MS2 around the connection MS3. In FIG. 1, the upper case MS1 and the lower case MS2 are being open to each other.

On a front face of the upper case MS1 shown in FIG. 1, disposed are an earpiece 14a and a display 15a. The earpiece 14a is used for receiving incoming voices. The display 15a is formed, e.g., by a liquid crystal display (LCD) device with a backlight. The display 15a is used for displaying an indication that prompts an operation, for displaying an indication of an operation having been done, and for displaying a cursor and an indication of operating condition of the radio communication apparatus.

On a front face of the lower case MS2 shown in FIG. 1, disposed are a microphone 14b and a keyboard 16a. The microphone 14b is used for sending outgoing voices. The keyboard 16a includes a plurality of keys. The lower case MS2 contains an antenna 12a (not shown) usable for sending and receiving radio waves, a vibrator 17a (not shown) and a hard disk 18a (not shown). On a back face of the lower case MS2, disposed is a speaker 22a (not shown) usable for producing music sounds.

The keyboard 16a includes a middle selection key usable for selecting a menu item, confirming a selection and so on. The keyboard 16a includes a four-way navigation key that is placed around the middle selection key and is usable for moving the cursor displayed on the display 15a up and down, left and right, and so on.

The keyboard 16a includes a plurality of numeric keys each of which may toggle a numeral, letters (alphabets, Japanese phonetic letters, etc.) and symbols. Each of the numeric keys may be used for entering, e.g. a phone number of a person to be called. The keyboard 16a includes a plurality of function keys each of which may be assigned an operation, like turning on and off power to the radio communication apparatus of the embodiment.

The connection MS3 contains a detector (not shown) that may detect whether the upper case MS1 and the lower case MS2 are being open or closed to each other. An output of the detector indicating whether the upper case MS1 and the lower case MS2 are being open or closed to each other is hereinafter called a detector indication MS3a.

The detector may be formed by a key switch (not shown) disposed on the front face of the lower case MS2 that may be pressed by a convex portion of the front face of the upper case MS1 while the upper case MS1 and the lower case MS2 are being closed to each other. The detector may detect whether the upper case MS1 and the lower case MS2 are being open or closed to each other according to whether the key switch is pressed or not.

The detector may be formed by a pair of magnets one of which is disposed in the upper case MS1 and the other of which is disposed in the lower case MS2. A location of each of the two magnets is arranged so that the two magnets are close to each other while the upper case MS1 and the lower case MS2 are being closed to each other. The detector may detect whether the upper case MS1 and the lower case MS2 are being open or closed to each other according to presence of magnetic force between the two magnets.

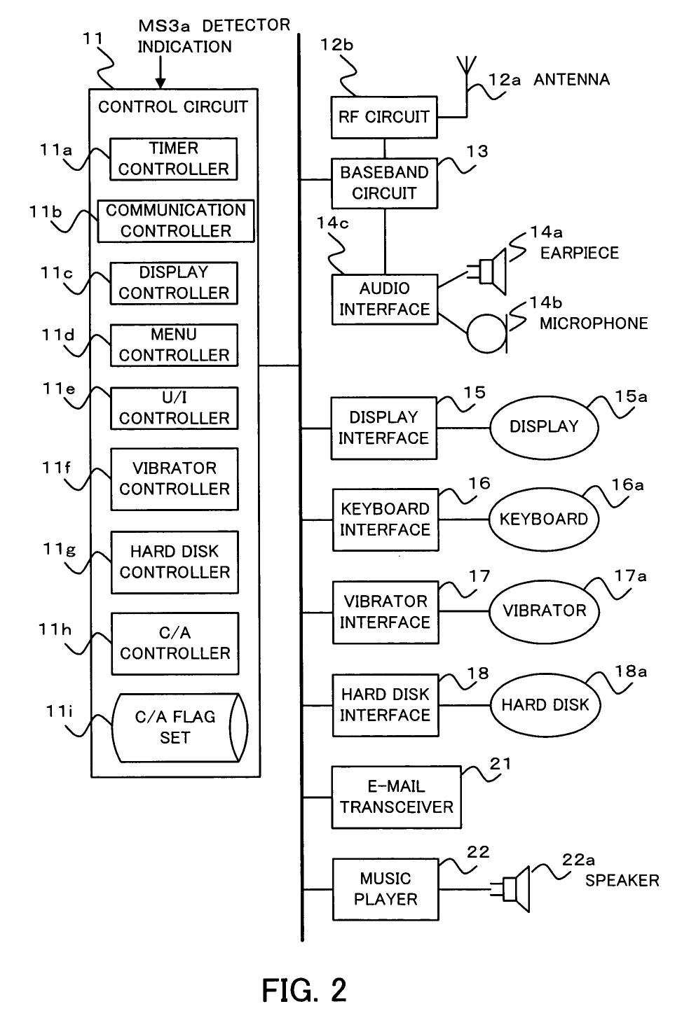

FIG. 2 is a block diagram of the radio communication apparatus of the embodiment of the present invention. The radio communication apparatus includes a control circuit 11 which controls each portion and a whole of the radio communication apparatus. The detector indication MS3a is applied to the control circuit 11.

The radio communication apparatus includes the antenna 12a configured to send and receive radio waves to and from a base station (not shown). The radio communication apparatus includes an RF circuit 12b, a baseband circuit 13, an earpiece 14a configured to receive incoming voices, a microphone 14b configured to send outgoing voices and an audio interface 14c.

The radio communication apparatus includes the display 15a and a display interface 15 configured to control displays on the display 15a. The radio communication apparatus includes the keyboard 16a and a keyboard interface 16. After one of the keys of the keyboard 16a is pressed, the keyboard 16a sends a signal identifying the pressed key to the keyboard interface 16.

The radio communication apparatus includes the vibrator 17a and a vibrator interface 17 configured to control vibration of the vibrator 17a. The radio communication apparatus includes the hard disk 18a and a hard disk interface 18 configured to write data including emails and music content on the hard disk 18a to be stored in and read out from the hard disk 18a. The hard disk 18a includes a head and a plurality of platters.

The radio communication apparatus includes an email transceiver 21, the speaker 22a and a music player 22. The speaker 22a is configured to produce a music sound played by the music player 22.

The control circuit 11 includes a timer controller 11a, a communication controller 11b, a display controller 11c, a menu controller 11d, an user interface controller (hereinafter shortened as the U/I controller) 11e, a vibrator controller 11f, a hard disk controller 11g and a conflict avoidance controller (hereinafter shortened as the C/A controller) 11h. The control circuit 11 keeps a conflict avoidance flag set (hereinafter shortened as the C/A flag set) 11i in an own memory.

2. Operation of Each portion of the Apparatus

Operation of each portion of the radio communication apparatus of the embodiment of the present invention will be described with reference to FIG. 2. The timer controller 11a is configured to send present time in response to a request. The timer controller 11a is configured to make a response after counting a determined period of time since a determined event occurs.

The communication controller 11b is configured to make the baseband circuit 13 request an outgoing call and have the call upon being informed by the U/I controller 11e that the call has been requested by a determined key operation on the keyboard 16a. The communication controller 11b is configured to make the baseband circuit 13 send an outgoing email in response to a request for sending the email from the email transceiver 21.

The communication controller 11b is configured to make the music player 22 pause a piece of music content stored in the hard disk 18a and being played, upon being informed by the baseband circuit 13 of an arrival of an incoming call (call arrival).

The communication controller 11b is configured to make the music player 22 provide the speaker 17a with a call arrival sound kept in an own memory of the music player 22. While producing the call arrival sound, the communication controller 11b may simultaneously make the vibrator 17a vibrate through the vibrator interface 11f so as to announce the call arrival.

The communication controller 11b is configured to make the baseband circuit 13 accept an incoming call and have the call upon being informed by the U/I controller 11e that the incoming call may be accepted by a determined key operation on the keyboard 16a.

After finishing the call that has been informed of while the piece of music content stored in the hard disk 18a is being played, the communication controller 11b is configured to make the music player 22 resume playing the piece of music content.

The communication controller 11b is configured to make the music player 22 provide the speaker 17a with an email arrival sound upon being informed by the baseband circuit 13 of an incoming email arrival. While producing the email arrival sound, the communication controller 11b may simultaneously make the vibrator 17a vibrate through the vibrator interface 11f so as to announce the email arrival.

The communication controller 11b is configured to make the email transceiver 21 receive the incoming email. The email transceiver 21 is configured to inform the communication controller 11b that the received email has been displayed.

There may be an incoming call arrived but cancelled by its sender before being accepted, which is called an unanswered call hereafter. Before the U/I controller 11e informs the communication controller 11b that the unanswered call has been checked by a determined key operation on the keyboard 16a, the unanswered call remains unchecked and presence of that unchecked-unanswered call is kept in an own memory of the communication controller 11b.

Suppose that the email transceiver 21 has received an incoming email, but has not informed the communication controller 11b yet that the email has been displayed. The email remains unread and presence of the unread email is kept in the memory of the communication controller 11b.

The communication controller 11b is configured, while keeping the presence of an unchecked-unanswered call in its memory, to make the vibrator interface 11f announce the presence of the unchecked-unanswered call by vibration of the vibrator 17a, in a case where the detector indication MS3a indicates a change that the upper case MS1 and the lower case MS2 are open after being closed to each other.

The communication controller 11b is configured, while keeping the presence of an unread email in its memory, to make the vibrator interface 11f announce the presence of the unread email by vibration of the vibrator 17a, in a case where the detector indication MS3a indicates a change that the upper case MS1 and the lower case MS2 are open after being closed to each other.

The display controller 11c makes the display interface 15 display information requested by each portion of the radio communication apparatus on the display 15a.

The menu controller 11d makes the display interface 15 display a menu requested by each portion of the radio communication apparatus on the display 15a. After a determined key of the keyboard 16a is pressed, the menu controller 11d receives via the U/I controller 11e a signal identifying the pressed key and sends the signal to the above portion of the radio communication apparatus.

After a determined key of the keyboard 16a is pressed, the U/I controller 11e receives via the keyboard interface 16 a signal identifying the pressed key and sends the signal to each portion of the radio communication apparatus.

The vibrator controller 11f controls the vibrator interface 17 so that the vibrator 17a vibrates upon receiving a request for vibration from each portion of the radio communication apparatus. The vibrator controller 11f may make the vibrator 17a vibrate via the C/A controller 11h.

Specifically speaking, the vibrator controller 11f controls the vibrator interface 17 so that the vibrator 17a vibrates upon being requested by the communication controller 11b after an incoming call arrival or an incoming email arrival is informed. The vibrator controller 11f makes the vibrator 17a vibrate via the° C/A controller 11h upon being requested by the communication controller 11b keeping the presence of an unchecked-unanswered call or an unread email in its memory, after the detector indication MS3a indicates a change that the upper case MS1 and the lower case MS2 are open after being closed to each other.

In each event described above, the vibrator 17a may vibrate according to a vibration pattern selected out of a plurality of given vibration patterns. For the above selection, the vibrator controller 11f makes the menu controller 11d display on the display 15a a menu of the vibration patterns, each of which is identified by a reference numeral, so that one of the vibration patterns may be preselected by a determined key operation on the keyboard 16a, e.g., putting the cursor on a preselected one.

The vibrator controller 11f makes the vibrator 17a vibrate according to the preselected vibration pattern via the C/A controller 11h for a short while. The vibrator controller 11f determines one of the vibration patterns preselected for each event described above by another determined key operation on the keyboard 16a, e.g., pressing the middle selection key, and keeps a result of the above determination in an own memory of the vibrator controller 11f.

The hard disk controller 11g is requested by each portion of the radio communication apparatus to access a specified address on the hard disk 18a, i.e., to write data onto the specified address or to read out data from the specified address. In response to the request, the hard disk controller 11g asks the C/A controller 11h if the access to the hard disk 18a is allowed or banned.

Upon obtaining an answer of “allowed”, the hard disk controller 11g makes the hard disk interface 18 read out data from the specified address and sends the data to the portion having requested the access, or the hard disk controller 11g makes the hard disk interface 18 write data onto the specified address.

Upon obtaining an answer of “banned”, the hard disk controller 11g does not access the hard disk 18a. Upon obtaining an answer of “banned” while accessing the hard disk 18a, the hard disk controller 11g stops the hard disk 18a from operating by moving the head aside and by stopping the platters from rotating. Upon obtaining an answer of “banned”, the hard disk controller 11g may ask the C/A controller 11h if the access to the hard disk 18a is allowed or banned a given period of time after obtaining the answer.

Upon being requested by the vibrator controller 11f to make the vibrator 17a vibrate, the C/A controller 11h determines if the vibration is allowed or banned. Upon determining that the vibration is allowed, the C/A controller 11h makes the vibrator 17a vibrate. Upon determining that the vibration is banned, the C/A controller 11h does not make the vibrator 17a vibrate.

Upon being asked if the access to the hard disk 18a is allowed or banned, the C/A controller 11h manages to avoid conflict between vibration of the vibrator 17a and operation of the hard disk 18a, i.e., prevents the vibrator 17a and the hard disk 18a from vibrating or operating simultaneously, by answering either “allowed” or “banned”.

The above conflict avoidance is controlled according to a priority condition set in the C/A controller 11h by a determined key operation on the keyboard 16a and according to whether the vibrator 17a or the hard disk 18a is allowed to vibrate or operate as defined in the C/A flag set 11i. The C/A flag set 11i includes data regarding if the access to the hard disk 18a is either allowed or banned and regarding if the vibration of the vibrator 17a is either allowed or banned.

The RF circuit 12b provides the baseband circuit 13 with an incoming RF signal that the antenna 12a receives. The RF circuit 12b transmits via the antenna 12a an outgoing RF signal provided by the baseband circuit 13.

The baseband circuit 13 amplifies, down-converts and demodulates the incoming RF signal provided by the RF circuit 12b so as to produce a digital voice signal or a digital control signal. The base band circuit 13 provides the audio interface 14c with the digital voice signal, and provides the communication controller 11b with the digital control signal.

The baseband circuit 13 modulates, up-converts and amplifies a digital voice signal obtained from the audio interface 14c or a digital control signal obtained from the communication controller 11b so as to produce the outgoing RF signal. The baseband circuit 13 provides the RF circuit 12b with the outgoing RF signal.

The audio interface 14c converts the digital voice signal provided by the baseband circuit 13 into an analog voice signal. The audio interface 14c amplifies the analog voice signal and provides the earpiece 14a with the amplified analog voice signal.

The audio interface 14c amplifies an analog voice signal obtained from the microphone 14b, and converts the amplified analog voice signal into a digital voice signal. The audio interface 14c provides the baseband circuit 13 with the converted digital voice signal.

The display interface 15 displays images and text including a cursor, characters and numerals on the display 15a under control of the display controller 11c. What is displayed on the display 15a may be changed upon being directed by the U/I controller 11 e according to a notification from the keyboard interface 15, or may be changed upon being requested by the communication controller 11b according to an incoming call arrival.

If a key of the keyboard 16a is pressed, the keyboard interface 16 provides the U/I controller 11e with an identifier of the pressed key. The display interface 15 may display on the display 15a a character assigned to the pressed key under control of the U/I controller 11e. The communication controller 11b may start or end a communication task according to a function assigned to the pressed key.

The vibrator interface 17 makes the vibrator 17a vibrate according to specified one of the vibration patterns under control of the vibrator controller 11f.

The hard disk interface 18 makes the platters of the hard disk 18a rotate and accesses the hard disk 18a under control of the hard disk controller 11g.

The email transceiver 21 is activated by the U/I controller 11e after a determined key operation on the keyboard 16a. The email transceiver 21 makes out an outgoing email according to a determined key operation, and transmits the outgoing email via the communication controller 11b.

The email transceiver 21 is activated if the communication controller 11b is informed of an incoming email arrival, and receives the incoming email. The email transceiver 21 displays on the display 15a reception of the incoming email. If a file including music content is attached to the received email, the email transceiver 21 asks the hard disk controller 11g to store the music content on the hard disk 18a.

The email transceiver 21 displays the received email on the display 15a via the display controller 11c. The email transceiver 21 informs the communication controller 11b that the received email has been displayed. The email transceiver 21 informs the communication controller 11b that a portion of the received email, e.g., a piece of information identifying a sender thereof, has been displayed.

The music player 22 is activated by the communication controller 11b, and provides the speaker 22a with a call arrival sound stored in the music player 22. The music player 22 is activated by the U/I controller 11e after a determined key operation on the keyboard 16a, reads out a piece of music content stored in the hard disk 18a via the hard disk controller 11g, and provides the speaker 22a with a sound signal of the piece of music content.

An operation of the control circuit 11 to avoid conflict between vibration of the vibrator 17a and operation of the hard disk 18a will be described in following paragraphs.

3. Conflict Avoidance between the Vibrator and the Hard Disk

3.1 Setting C/A Flag Set

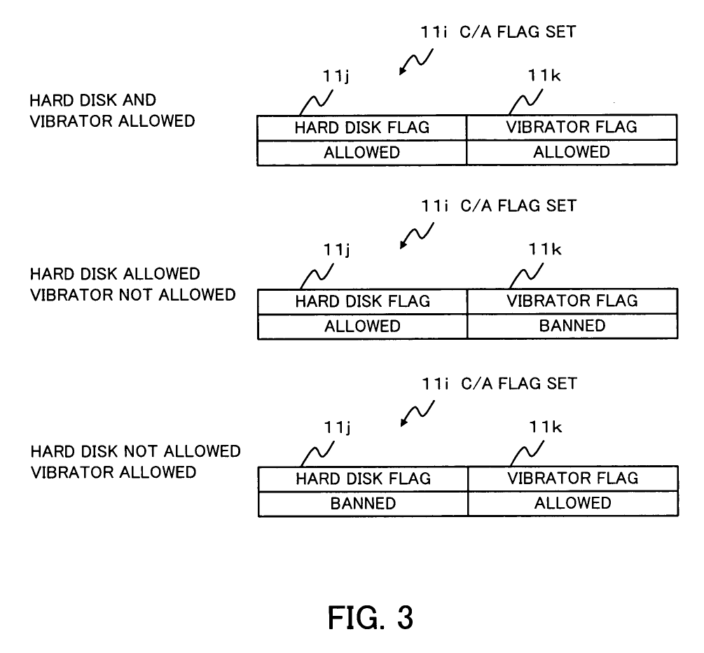

The C/A flag set 11i is formed, e.g., as shown in FIG. 3. The C/A flag set 11i is formed by a hard disk flag 11j and a vibrator flag 11k. The hard disk flag 11j shows if the hard disk 18a is allowed to operate. The vibrator flag 11k shows if the vibrator 17a is allowed to vibrate.

In a first example of the C/A flag set 11i in an upper table of FIG. 3, the hard disk flag 11j is set allowed, and the vibrator flag 11k is set allowed. The first example indicates that the hard disk 18a may operate upon being requested to operate, and that the vibrator 17a may vibrate upon being requested to vibrate. The first example may appear in the C/A flag set 11i if, e.g., a power switch of the radio communication apparatus is turned on.

In a second example of the C/A flag set 11i in a middle table of FIG. 3, the hard disk flag 11j is set allowed, and the vibrator flag 11k is set banned. The second example indicates that the hard disk 18a may operate upon being requested to operate, and that the vibrator 17a may not vibrate in spite of a request for vibration. The second example may appear in the C/A flag set 11i if, e.g., the vibrator 17a is ready to vibrate according to an operation on the keyboard 16a but is preceded by the hard disk 18a.

In a third example of the C/A flag set 11i in a lower table of FIG. 3, the hard disk flag 11j is set banned, and the vibrator flag 11k is set allowed. The third example indicates that the hard disk 18a may not operate in spite of a request for an access thereto, and that the vibrator 17a may vibrate upon being requested to vibrate. The third example may appear in the C/A flag set 11i if, e.g., the vibrator 17a is ready to vibrate according to an operation on the keyboard 16a and precedes the hard disk 18a.

The hard disk 18a may not completely be banned from operating if the hard disk flag 11j is set banned. As described later, the hard disk 18a may operate after a pause in vibration of the vibrator 17a. The vibrator 17a may not completely be banned from vibrating if the vibrator flag 11k is set banned. As described later, the vibrator 17a may vibrate after a pause in operation of the hard disk 18a.

3.2 Control of the Hard disk 18a Requested by the Email Transceiver 21 or the Music Player 22

One of the email transceiver 21 and the music player 22 may request the hard disk controller 11g to access the hard disk 18a. The hard disk controller 11g may ask the C/A controller 11h whether the access to the hard disk 18a is allowed. If the C/A controller 11h answers that the access is allowed, the hard disk controller 11g may access the hard disk 18a. If the C/A controller 11h answers that the access is banned, the hard disk controller 11g stops the hard disk 18a from operating and displays the answer on the display 15a via the display controller 11c.

After a determined period of time, one of the email transceiver 21 and the music player 22 may request the hard disk controller 11g to access the hard disk 18a.

Upon being asked whether the access to the hard disk 18a is allowed, the C/A controller 11h answers that the access is allowed if the hard disk flag 11j is set allowed. Upon being asked whether the access to the hard disk 18a is allowed, the C/A controller 11h answers that the access is banned if the hard disk flag 11j is set banned.

After answering that the access is allowed upon being asked by the hard disk controller 11g, the C/A controller 11h may set the vibrator flag 11k banned. Although in this case being banned to vibrate, the vibrator 17a may vibrate, as described later, after a pause in operation of the hard disk 18a under control of the C/A controller 11h. Besides, the hard disk controller 11g informs the C/A controller 11h of an end of the access to the hard disk 18a, and the C/A controller 11h sets the vibrator flag 11k allowed.

In a case where the hard disk flag 11j is set banned, the C/A controller 11h may control the vibrator controller 11f so that the vibrator 17a stops vibrating, and then answers that the access is allowed upon being asked by the hard disk controller 11g.

3.3 Control of the Vibrator 17a to Announce Call Arrival

After being informed by the baseband circuit 13 of an incoming call arrival, as earlier described, the communication controller 11b makes the music player 22 pause a piece of music content stored in the hard disk unit 18a and being played. As the hard disk 18a resultantly stops operating, the vibrator 17a may vibrate so as to announce the call arrival while preceding the hard disk 18a, and may thus avoid a conflict with the operation of the hard disk 18a.

After finishing the above call, the communication controller 11b makes the music player 22 resume the piece of music content stored in the hard disk 18a and having been played before the call arrival. The vibrator 17a may thus precede the hard disk 18a and may vibrate to announce a call arrival depending on neither the C/A controller 11h nor the C/A flag set 11i.

3.4 Control of the Vibrator 17a to Announce Email Arrival

The C/A controller 11h determines, according to the C/A flag set 11i, if the vibrator 17a precedes the hard disk 18a in a case where the vibrator 17a is ready to announce an email arrival.

The vibrator controller 11f requests the C/A controller 11h to make the vibrator 17a vibrate so as to announce an email arrival. The C/A controller 11h sets the hard disk flag 11j banned and makes the vibrator 17a vibrate if the vibration flag 11k is set allowed.

As the hard disk 18a may be operating while the vibrator flag 11k is set allowed, the C/A controller 11h asks the hard disk controller 11g, before making the vibrator 17a vibrate, whether the hard disk 18a is operating. If the hard disk controller 11g answers that the hard disk 18a is operating, the C/A controller 11h requests the hard disk controller 11g to stop the hard disk 18a from operating.

The C/A controller 11h does not make the vibrator 17a vibrate if the vibration flag 11k is set banned.

Upon being informed by the vibrator controller 11f that the request for the vibration of the email arrival is cancelled, the C/A controller 11h stops the vibrator 17a from vibrating, and sets the hard disk flag 11j allowed. Having requested the hard disk controller 11g to stop the hard disk 18a from operating before making the vibrator 17a vibrate, the C/A controller 11h informs the hard disk controller 11g that the vibrator 17a stops vibrating. The hard disk controller 11g may thus make the hard disk 18a resume operating.

The vibrator 17a may precede the hard disk 18a and may vibrate to announce an email arrival under control of the communication controller 11b depending on neither the C/A controller 11h nor the C/A flag set 11i, as well as to announce a call arrival. The vibrator 17a may be prevented from vibrating not depending on the C/A flag set 11i while the hard disk 18a is operating.

In order to announce an email arrival, as described above, the vibrator 17a may or may not vibrate in three possible ways, i.e., depending on the C/A flag set 11i, always preceding the hard disk 18a, or always being preceded by the hard disk 18a. In order to announce that the vibrator 17a is set to be used for announcing a call arrival or an email arrival, the vibrator 17a may or may not vibrate similarly in three possible ways.

3.5 Control of the Vibrator 17a to Announce Presence of Unchecked-unanswered Call or Unread Email

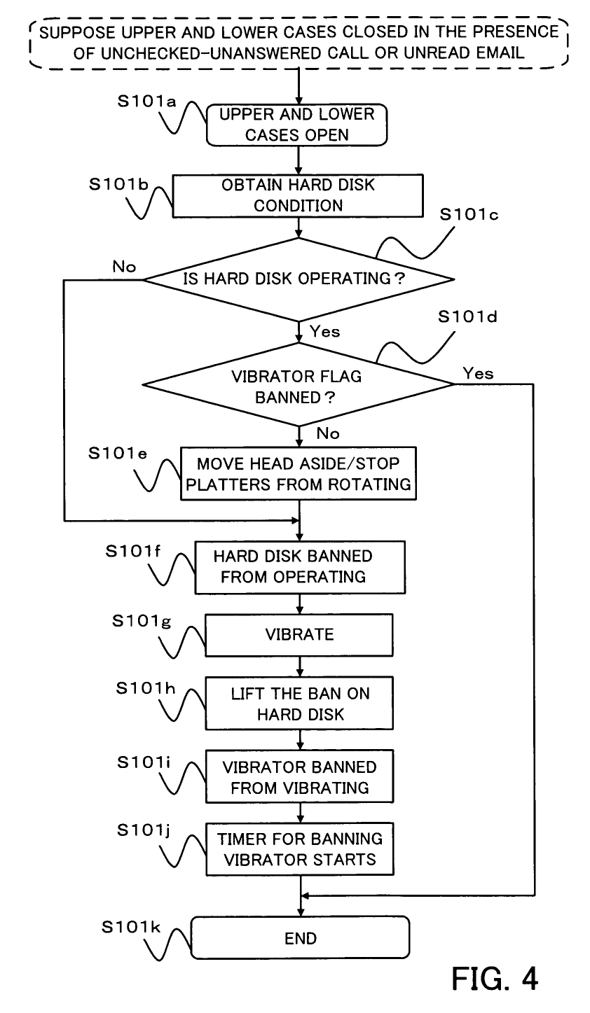

A flow chart of operation of the C/A controller 11h will be described with reference to FIGS. 4 to 6 in a case where the C/A controller 11h is requested to make the vibrator 17a vibrate for a given period of time so as to announce presence of an unchecked-unanswered call or an unread email while the hard disk 18a is operating. FIG. 4 shows an early stage of the flow chart.

Suppose, at first, that the detector indication MS3a indicates that the upper case MS1 and the lower case MS2 are closed in the presence of an unchecked-unanswered call or an unread email. After the detector indication MS3a indicates a change that the upper case MS1 and the lower case MS2 are open after being closed to each other, the C/A controller 11h is activated by the vibrator controller 11f (step S101a) and obtains information about condition of the hard disk 18a from the hard disk controller 11g (step S101b).

If the hard disk 18a is operating, i.e., the platters thereof are rotating (“Yes” of step S101c), the C/A controller 11h checks if the vibrator flag 11k is set banned (step S101d).

In a case where the C/A controller 11h is activated by the vibrator controller 11f at first, the vibrator flag 11k has seldom been set banned. In a case where the C/A controller 11h is repetitively activated, as described later, the vibrator flag 11k may have been set banned.

If the vibrator flag 11k is set allowed (“No” of step S101d), the C/A controller 11h makes the hard disk controller 11g stop the hard disk 18a from operating by moving the head aside and stopping the platters from rotating (step S101e). The C/A controller 11h sets the hard disk flag 11j banned so as to keep in its memory that the hard disk 18a is banned from operating (step S101f). The C/A controller 11h makes the vibrator 17a vibrate (step S101g).

The C/A controller 11h then lifts the ban on the hard disk 18a imposed at the step S101f (step S101h). That is, the C/A controller 11h sets the hard disk flag 11j allowed so as to keep in its memory that the hard disk 18a is allowed to operate, and sets the vibrator flag 11j banned so as to keep in its memory that the vibrator 17a is banned from vibrating (step S101i). The C/A controller 11h requests the timer controller 11a to activate the C/A controller 11h next time after waiting a determined period of time since the ban on the hard disk 18a (step S101j). The vibrator 17a is being banned from vibrating while the above determined period of time. The C/A controller 11h then ends the early stage of the flow chart (step S101k).

If the vibrator flag 11k is set banned (“Yes” of step S101d), the C/A controller 11h directly ends the early stage of the flow chart (step S101k). If the hard disk 18a is not operating at the step S101c, the C/A controller 11h directly sets the hard disk flag 11j banned so as to keep in its memory that the hard disk 18a is banned from operating (step S101f).

In a case where the upper case MS1 and the lower case MS2 are open after being closed to each other in the presence of an unchecked-unanswered call or an unread email, as described above, the vibrator 17a vibrates at the step S101g at least for a first time. If the hard disk 18a has been operating, the C/A controller 11h bans the hard disk 18a from operating while the vibrator 17a is vibrating (the steps S101f to S101h) so as to protect the hard disk 18a.

Suppose that the C/A controller 11h is requested to make the vibrator 17a vibrate again to announce the presence of an unchecked-unanswered call or an unread email before being activated by the timer controller 11a (requested at the step S101j), while the hard disk 18a is operating. The C/A controller 11h, having set the vibrator flag 11k banned at the step S101i, directly moves to the step S101k to end the flow chart at the step S101d, and thus prevents the vibrator 17a from vibrating.

The upper case MS1 and the lower case MS2 may be opened and closed within a short period of time while in the presence of an unchecked-unanswered call or an unread email. In such a case, the vibrator 17a may be prevented from vibrating to announce the presence of the unchecked-unanswered call or the unread email, and a piece of music content stored in the hard disk 18a may be continuously played and pleasantly enjoyed. In addition, power dissipation of the hard disk 18a may be reduced, and the hard disk 18a may be protected from deterioration.

Suppose that the C/A controller 11h keeps in its memory when the C/A controller 11h is activated last time upon obtaining the detector indication MS3a indicating that the upper case MS1 and the lower case MS2 are open. In such a case, at the step S101j, the C/A controller 11h may request the timer controller 11a to activate the C/A controller 11h next time after waiting a determined period of time not since the ban on the hard disk 18a but since the C/A controller is activated last time.

The C/A controller 11h may wait until the detector indication MS3a indicates a change that the upper case MS1 and the lower case MS2 are closed, and may request the timer controller 11a to activate the C/A controller 11h next time after waiting a determined period of time not since the ban on the hard disk 18a but since the above change of the detector indication MS3a.

In a case where a call takes place while the upper case MS1 and the lower case MS2 are open, the C/A controller 11h may wait for an end of the call, and may request the timer controller 11a to activate the C/A controller 11h next time after waiting a determined period of time not since the ban on the hard disk 18a but since the end of the call.

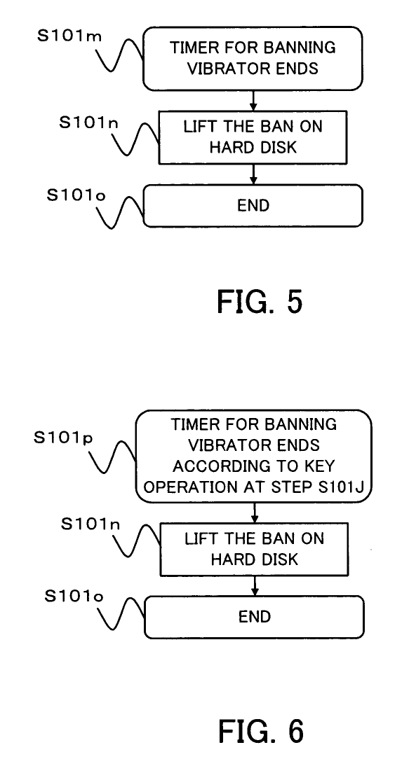

FIG. 5 shows a late stage of the flow chart started in FIG. 4, where the C/A controller 11h has been requested to make the vibrator 17a vibrate for a given period of time so as to announce the presence of an unchecked-unanswered call or an unread email while the hard disk 18a is operating. The late stage starts in FIG. 5 after the timer controller 11h activates the C/A controller 11h as requested at the step S101j in FIG. 4.

The C/A controller 11h is activated by the timer controller 11a after the timer controller 11a waits for the determined period of time while the vibrator 17a is banned from vibrating, and starts an operation of the late stage in FIG. 5 (step S101m). The C/A controller 11h lifts the ban on the vibrator 17a imposed at the step S101i, i.e., sets the vibrator flag 11k allowed (step S101n). The C/A controller 11h then ends the flow chart started in FIG. 4 (step S101o).

FIG. 6 shows a modified late stage of the flow chart started in FIG. 4. The modified late stage starts after the timer controller 11a activates the C/A controller 11h as requested at the step S101j in FIG. 4. The modified late stage shown in FIG. 6 is similar to the late stage shown in FIG. 5. The modified late stage shown in FIG. 6 includes a step which is a same as the corresponding one given the same reference numeral in FIG. 5, and its explanation is omitted.

Suppose, at the step S101j in FIG. 4, that the determined period of time is entered by a determined key operation on the keyboard 16a. The C/A controller 11h is activated by the timer controller 11a after the timer controller 11a waits for the above entered period of time while the vibrator 17a is banned from vibrating, and starts an operation of the modified late stage in FIG. 6 (step S101p). The C/A controller 11h then sets the vibrator flag 11k allowed.

The upper case MS1 and the lower case MS2 may be opened and closed at a time interval no shorter than a determined one in the presence of an unchecked-unanswered call or an unread email. In such a case, the vibrator 17a may vibrate so as to announce the above presence, and may help the above presence be reminded of.

The C/A controller 11h may keep an identifier of an unchecked-unanswered call or an unread email in its memory while making the vibrator 17a vibrate at the step S101g. The C/A controller 11h may make the vibrator 17a vibrate so as to announce presence of another unchecked-unanswered call of a different identifier or another unread email of a different identifier by following the steps S101e to S101k, even if the vibrator flag 11k is set banned showing that the vibrator 17a is banned from vibrating, or even between the step S101i where the vibrator 17a is banned from vibrating and the step S101n where the ban on the vibrator 17a is lifted.

The C/A controller 11h may not announce the presence of the unchecked-unanswered call of the identifier kept in its memory or the unread email of the identifier kept in its memory by making the vibrator 17a vibrate. The C/A controller 11h may announce the presence of the unchecked-unanswered call or the unread email by making the vibrator 17a vibrate only once.

In the above case, necessary is neither the step S101 i where the vibrator 17a is banned from vibrating, nor the step S101j where the timer controller 11a is requested to activate the C/A controller 11h after waiting for a determined period of time while the vibrator 17a is being banned from vibrating. Necessary is neither the late stage of the flow chart nor the modified late stage of the flow chart.

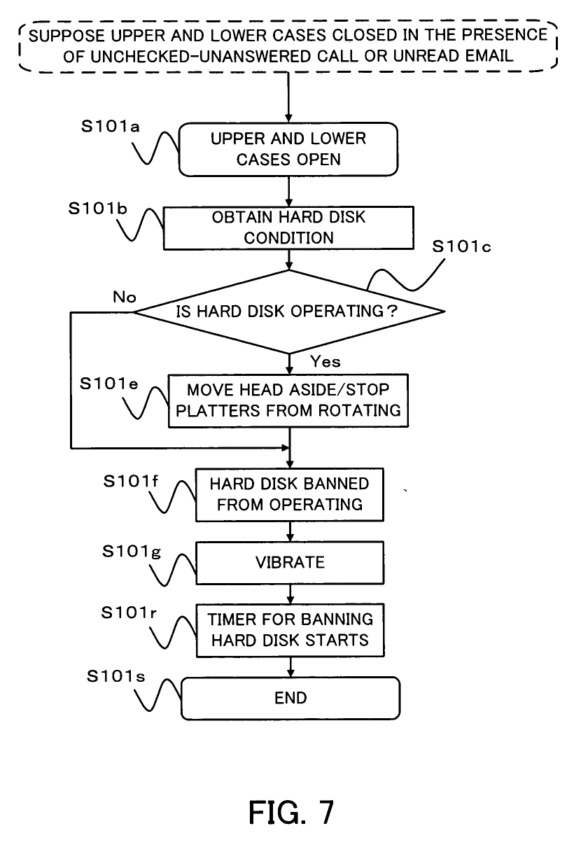

Another flow chart of operation of the C/A controller 11h will be described with reference to FIGS. 7 to 9 in a case where the C/A controller 11h is requested to make the vibrator 17a vibrate so as to announce presence of an unchecked-unanswered call or an unread email while the hard disk 18a is operating. FIG. 7 shows an early stage of the flow chart described as follows.

The flow chart shown in FIG. 7 is similar to the flow chart shown in FIG. 4, including a step which is a same as the corresponding one given the same reference numeral in FIG. 4, and its explanation is omitted. As in FIG. 4, it is supposed at first that the detector indication MS3a indicates that the upper case MS1 and the lower case MS2 are closed in the presence of an unchecked-unanswered call or an unread email.

After being activated, the C/A controller 11h stops the hard disk 18a from operating and makes the vibrator 17a vibrate without regard to an entry of the vibrator flag 11k by taking the steps S101a to S101c and S101e to S101g. Following the step S101g, the C/A controller 11h requests the timer controller 11a to activate the C/A controller 11h next time after waiting for a determined period of time (step S101 r). The C/A controller 11h then ends the flow chart shown in FIG. 7 (step S101s).

In a case where the upper case MS1 and the lower case MS2, which have been closed, open in the presence of an unchecked-unanswered call or an unread email, as described above, the vibrator 17a vibrates at the step S101g while the music player 22 is being prevented from playing a piece of music as the hard disk 18a is being banned from operating.

The above vibration urges the unchecked-unanswered call to be checked, or the unread email to be read. In addition, power dissipation of the hard disk 18a may be reduced, and the hard disk 18a may be protected from deterioration.

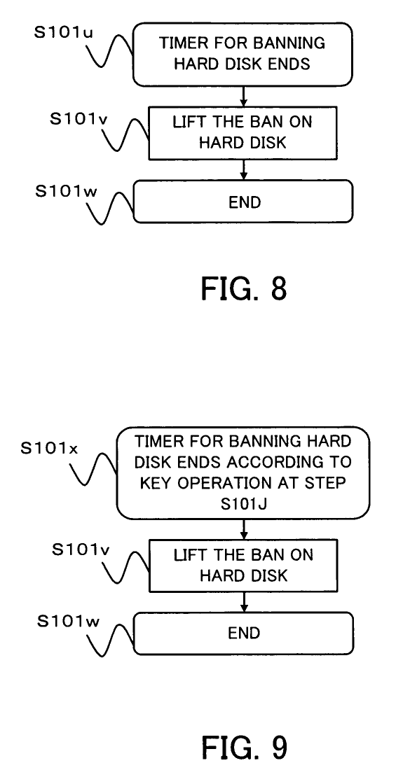

FIG. 8 shows a late stage of the flow chart started in FIG. 7, where the C/A controller 11h has been requested to make the vibrator 17a vibrate so as to announce presence of an unchecked-unanswered call or an unread email while the hard disk 18a is operating. The late stage starts in FIG. 8 after the timer controller 11h activates the C/A controller 11h as requested at the step S101 r in FIG. 7.

The C/A controller 11h is activated by the timer controller 11a after the timer controller 11a waits for the determined period of time given at the step S101 r in FIG. 7, and starts an operation of the late stage in FIG. 8 (step S101u). The C/A controller 11h lifts the ban on the hard disk 18a imposed at the step S101f, i.e., sets the hard disk flag 11j allowed (step S101v). The C/A controller 11h then ends the flow chart started in FIG. 7 (step S101w).

FIG. 9 shows a modified late stage of the flow chart started in FIG. 7. The modified late stage starts after the timer controller 11a activates the C/A controller 11h as requested at the step S101r in FIG. 7. The modified late stage shown in FIG. 9 is similar to the late stage shown in FIG. 8. The modified late stage shown in FIG. 9 includes a step which is a same as the corresponding one given the same reference numeral in FIG. 8, and its explanation is omitted.

Suppose, at the step S101r in FIG. 7, that the determined period of time is entered by a determined key operation on the keyboard 16a. The C/A controller 11h is activated by the timer controller 11a after the timer controller 11a waits for the above entered period of time, and starts an operation of the modified late stage in FIG. 9 (step S101x). The C/A controller 11h then sets the hard disk flag 11j allowed.

Setting the hard disk flag 11j allowed at the step S101v in FIG. 7, the C/A controller prevents the hard disk 18a from operating so that the music player 22 pauses a piece of music content being played for a determined period of time in the presence of the unchecked-unanswered call or the unread email. After the determined period of time, the C/A controller 11h allows the hard disk 18a to operate so that the music player 22 resumes playing the piece of music content.

It may thus be avoided that the music player 22 indefinitely pauses the piece of music content that has been played, in a case where it is improbable that the unchecked-unanswered call is checked or the unread email is read.

In a case where the unchecked-unanswered call or the unread email is gone during the above determined period of time, the communication controller 11b informs the C/A controller 11h that the unchecked-unanswered call or the unread email is gone. Setting the hard disk flag 11j allowed, the C/A controller 11h may allow the hard disk 18a to operate so that the music player 22 resumes playing a piece of music content.

3.6 Control of the Vibrator 17a to Select Vibration Patterns

In an event of an incoming call arrival and so on, as earlier described, the vibrator controller 11f makes the menu controller 11d display on the display 15a a menu of the vibration patterns, each of which is identified by a reference numeral, so that one of the vibration patterns may be preselected. The vibrator controller 11f makes the vibrator 17a vibrate according to the preselected one of the vibration patterns for a short while, determines one of the vibration patterns for each event, and keeps a result of the above determination in its memory.

The vibrator controller 11f starts selecting one of the vibration patterns after a determined key operation on the keyboard 16a. One of the above events is identified by a determined key operation on the keyboard 16a. The vibrator controller 11f displays the menu of the vibration patterns on the display 15a, and informs the C/A controller 11h that the above menu has been displayed.

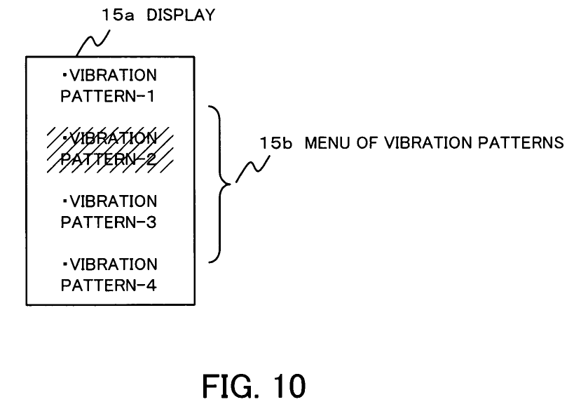

FIG. 10 shows an example of the menu of the vibration patterns, each of which is identified by a reference numeral. In FIG. 10, a menu of the vibration patterns 15b is displayed on the display 15a. The menu 15b includes four entries, “vibration pattern-1”, “vibration pattern-2”, “vibration pattern-3” and “vibration pattern-4” arranged in a vertical direction on the display 15a. The cursor is put on one of the four entries.

The cursor may be moved upward or downward by, e.g., an operation of the four-way navigation key included in the keyboard 16a. Preselected one of the entries on which the cursor is put is distinctively presented so as to be distinguished from the other entries. In FIG. 10, the cursor is put on the vibration pattern-2, which is distinctively shown by being given hatching.

The vibrator controller 11f requests the C/A controller 11h to make the vibrator 17a vibrate according to one of the vibration patterns to which the cursor has been moved.

If the middle selection key included in the keyboard 16a is pressed, the vibrator controller 11f selects for the event identified above the vibration pattern of the preselected entry on which the cursor is put, and keeps the selected vibration pattern in its memory. The vibrator controller 11 f ends the display of the menu 15b, informs the C/A controller 11h that the display of the menu 15b has been ended, and thus ends selecting one of the vibration patterns.

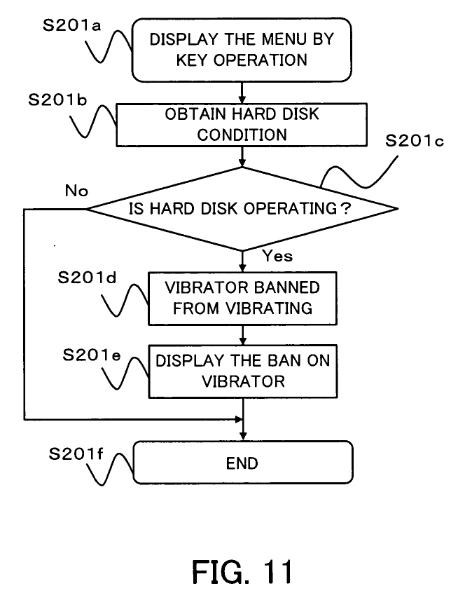

FIG. 11 shows an early stage of a flow chart of operation of the C/A controller 11h avoiding a conflict between operation of the hard disk 18a and the vibration of the vibrator 17a requested by the vibrator controller 11f to preselect one of the vibration patterns described above.

The C/A controller 11h starts the operation so as to avoid the above conflict upon being informed that the menu 15b has been displayed on the display 15a by a determined key operation on the keyboard 16a (step S201a). The C/A controller 11h obtains information about condition of the hard disk 18a from the hard disk controller 11g (step S201b).

If the hard disk 18a is operating, i.e., the platters thereof are rotating (“Yes” of step S201c), the C/A controller 11h sets the vibrator flag 11k banned and bans the vibrator 17a from vibrating (step S201d). The C/A controller 11h displays that the vibrator 17a is banned from vibrating (step S201e), and ends the early stage of the flow chart (step S201f).

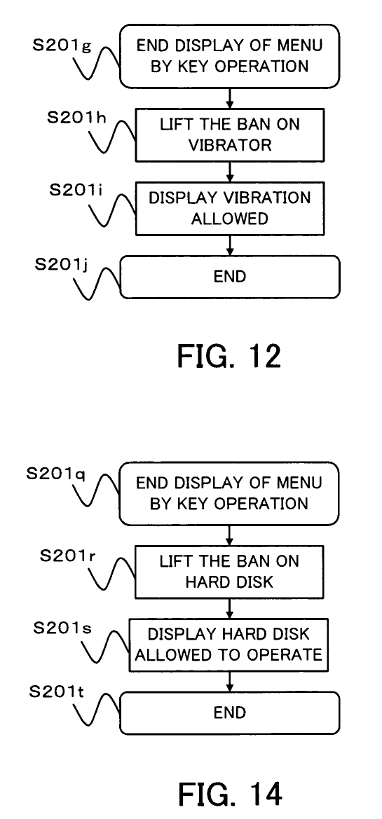

FIG. 12 shows a late stage of the flow chart started in FIG. 11 so as to avoid a conflict between operation of the hard disk 18a and the vibration of the vibrator 17a requested by the vibrator controller 11f to preselect one of the vibration patterns described above.

The C/A controller 11h starts avoiding the conflict upon being informed by the vibrator controller 11f that the display of the menu 15b has ended by a determined key operation (step S201g). The C/A controller 11h lifts the ban on the vibrator 17a imposed at the step S201d in FIG. 11, i.e., sets the vibrator flag 11k allowed, thus allows the vibrator 17a to vibrate (step S201h). The C/A controller 11h displays for a determined period of time that the vibrator 17a is allowed to vibrate, instead of displaying the ban on the vibrator 17a (step S201 i), and ends the flow chart started in FIG. 11 (step S201j).

An event of unpleasant interruption of a play of the music content by the music player 22 may be avoided by taking the steps shown in FIG. 11 and FIG. 12. Besides, the C/A controller 11h urges the music player 22 to pause a piece of music content being played before allowing the vibrator 17a to vibrate. The vibration for preselecting the vibration pattern, being less important, may be deferred as directed by a user. As the vibration for announcing an incoming call arrival is important, on the other hand, the vibrator 17a should vibrate while interrupting the play of music content as earlier described.

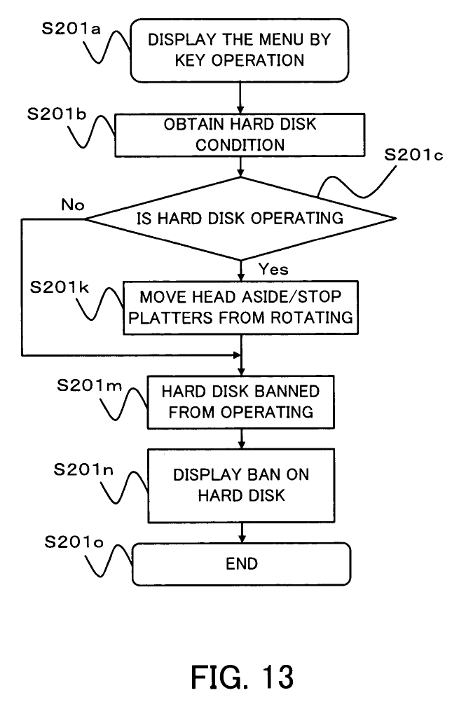

FIG. 13 shows an early stage of another flow chart of operation of the C/A controller 11h avoiding a conflict between operation of the hard disk 18a and the vibration of the vibrator 17a requested by the vibrator controller 11f to preselect one of the vibration patterns described above. The flow chart shown in FIG. 13 includes a step which is a same as the corresponding one given the same reference numeral in FIG. 11, and its explanation is omitted.

If the hard disk 18a is operating at the step S201c, i.e., the platters thereof are rotating, the C/A controller 11h makes the hard disk controller 11g stop the hard disk 18a from operating by moving the head aside and stopping the platters from rotating (step S201k). If the hard disk 18a is not operating at the step S201c, the step S201k is bypassed. The C/A controller 11h then sets the hard disk flag 11k banned and bans the hard disk 18a from operating (step S201m).

The C/A controller 11h displays on the display 15a that the hard disk 18a is being banned from operating (step S201n), and ends the early stage of the flow chart shown in FIG. 13.

FIG. 14 shows a late stage of the flow chart started in FIG. 13 so as to avoid a conflict between operation of the hard disk 18a and the vibration of the vibrator 17a requested by the vibrator controller 11f to preselect one of the vibration patterns described above.

The C/A controller 11h starts avoiding the conflict upon being informed by the vibrator controller 11f that the display of the menu 15b has ended by a determined key operation (step S201q). The C/A controller 11h lifts the ban on the hard disk 18a imposed at the step S201dm in FIG. 13, i.e., sets the hard disk flag 11j allowed, thus allows the hard disk 18a to operate (step S201 r). The C/A controller 11h displays for a determined period of time that the hard disk 18a is allowed to operate, instead of displaying the ban on the hard disk 18a (step S201s), and ends the flow chart started in FIG. 13 (step S201t).

While the menu 15b of the vibration patterns is being displayed, it is recognized that the vibrator 17a may vibrate according to the vibration pattern preselected by a determined key operation. Meanwhile, the hard disk 18a may be prevented from operating by taking the steps shown in FIG. 13 and FIG. 14.

As the vibrator should vibrate upon being operated by a user at his or her discretion in the above case, it may be agreeable to the user that the hard disk 18a stops operating and the music player 22 thereby stops operating. As the hard disk 18a stops operating while the menu 15b is being displayed on the display 15a, it may be agreeable to the user that the vibrator 17a may vibrate soon after the determined key operation on the keyboard 16a.

After the menu 15b of the vibration patterns is displayed, as described earlier, the vibrator controller 11f informs the C/A controller 11h that the menu 15b has been displayed. Instead, the vibrator controller 11f may inform the C/A controller 11h after the cursor is moved upward or downward by, e.g., an operation of the four-way navigation key included in the keyboard 16a, i.e., just before making the vibrator 17a vibrate for preselecting one of the vibration patterns.

In the above case, if the vibrator controller 11f may start operation for determining one of the vibration patterns according to an erroneous operation of a user without regard to his or her real intention and the user is immediately aware of the error and cancels the operation for determining one of the vibration patterns, i.e., ends the operation of the vibrator controller 11f for determining one of the vibration patterns without an operation making the vibrator 17a vibrate, the C/A controller 11h does neither make the vibrator 17a vibrate for preselecting one of the vibration patterns nor avoid the conflict between the hard disk 18a and the vibrator 17a. In this case, the operation of avoiding the conflict is unnecessary.

As described earlier, the hard disk 18a stops operating by stopping the platters from rotating and moving the head aside. Instead, the hard disk 18a may stop operating by moving the head aside, because it is improbable that the vibrator 17a adversely affects the hard disk 18a if the head remains aside even while the platters are rotating. In this case, whether the hard disk 18a is operating or not is determined by whether the head does or does not remain aside while the platters are rotating. Besides, if the hard disk 18a stops operating continuously over a determined period of time, the platters may stop rotating while the head remains aside.

The embodiment of the present invention has been described taking avoidance of a conflict between vibration of the vibrator 17a and operation of the hard disk 18a as an example. The embodiment of the present invention may be applied, as a matter of course, to avoidance of a conflict between vibration of the vibrator 17a and operation of a device that should remain vibration-free while operating.

An example of such a device is a storage device accompanying mechanical movement of its storage element for being accessed. The storage device may be of a drum type or of a planar type. The storage device may use magnetism or presence of reflection or permeation of light for being accessed. Another example of such a device is a digital still camera or a digital video camera.

As described earlier, the upper case MS1 may be open or closed to the lower case MS2 by rotating against the lower case MS2. Instead, the upper case MS1 may be open or closed to the lower case MS2 by sliding over the lower case MS2. In that case, the upper case MS1 and the lower case MS2 are open if the display 15a and/or the keyboard 16a may be seen by a user, and the upper case MS1 and the lower case MS2 are closed otherwise.

In the above description, the embodiment of the present invention has been applied to the radio communication apparatus. Instead, the present invention may be applied, as a matter of course, to a data processing apparatus including a device that may vibrate and a device that should remain vibration-free.

The particular hardware or software implementation of the present invention may be varied while still remaining within the scope of the present invention. It is therefore to be understood that within the scope of the appended claims and their equivalents, the invention may be practiced otherwise than as specifically described herein.

What is claimed is:

1. A radio communication apparatus, comprising:
an input device;
a storage device including a storage elememt, the storage device configured to operate accompanying a mechanical move of the storage elememt;
a vibrating device; and
a controller
configured to prevent the storage device from operating upon a determined operation input entered from the input device while the storage device is operating,
the controller configured to make the vibrating device vibrate according to the determined operation input,
the controller configured to make the storage device resume operating after the vibrating device vibrates, and
the controller configured to prevent the vibrating device from vibrating for a determined period of time after the storage device resumes operating.

2. The radio communication apparatus of claim 1, wherein the controller is further configured to make the vibrating device continue vibrating while preventing the storage device from operating until an operation input different from the determined operation input is entered from the input device.

3. The radio communication apparatus of claim 1, wherein the storage device is a hard disk and the vibrating device is configured to vibrate so as to announce an incoming call arrival.

4. A radio communication apparatus, comprising:
a case configured to be in one of first mechanical condition and second mechanical condition;
a detector configured to detect that the case is in one of the first mechanical condition and the second mechanical condition;
a storage device including a storage elememt, the storage device configured to operate accompanying a mechanical move of the storage elememt;
a vibrating device;
a first controller including a memory, the first controller configured to keep presence of an unanswered call in the memory; and
a second controller
configured to prevent the storage device from operating and make the vibrating device vibrate in a case where the first controller keeps the presence of the unanswered call in the memory while the case is in the first mechanical condition and the detector detects a change that the case is in the second mechanical condition while the storage device is operating, and
the second controller configured to prevent the vibrating device from vibrating if the storage device is operating for a determined period of time after the vibrating device vibrates.

5. The radio communication apparatus of claim 4, wherein the storage device is a hard disk and the vibrating device is configured to vibrate so as to announce an incoming call arrival.

6. The radio communication apparatus of claim 4, wherein the case includes a first portion and a second portion configured to be movably connected to the first portion.

7. A radio communication apparatus, comprising:
an input device including a plurality of input elements;
a display device;
a storage device including a storage elememt, the storage device configured to operate accompanying a mechanical move of the storage elememt;
a vibrating device configured to vibrate according to one of a plurality of determined vibration patterns;
a vibration selector
configured to display information identifying the vibration pattern on the display device,
the vibration selector configured to select one of the vibration patterns displayed on the display device if determined one of the input elements is operated, and
the vibration selector configured to make the vibrating device vibrate according to the selected vibration pattern; and
a controller configured to prevent the storage device from operating in a case where one of the vibration patterns may be selected while the storage device is operating.

8. The radio communication device of claim 7, wherein the controller is configured to prevent the storage device from operating while the information identifying the vibration pattern is being displayed on the display device.

9. The radio communication device of claim 7, wherein the controller is configured to prevent the storage device from operating if one of the vibration patterns is selected while the storage device is operating.

10. The radio communication apparatus of claim 7, wherein the storage device is a hard disk and the vibrating device is configured to vibrate so as to announce an incoming call arrival.
